(19) United States
(12) Patent Application Publication
(10) Pub. No.: US 2015/0163394 A1
(43) Pub. Date: Jun. 11, 2015

(54) Automatic-Focusing Imaging Capture Device and Imaging Capture Method

(71) Applicant: NOVATEK Microelectronics Corp., Hsin-Chu (TW)

(72) Inventors: Shen-Fu Tsai, Taoyuan County (TW); Wei Hsu, Taoyuan County (TW); Min-Hui Chu, Hsinchu County (TW); Chin-Hui Huang, Hsinchu City (TW); Wei-Lung Liu, Hsinchu County (TW)

(73) Assignee: NOVATEK Microelectronics Corp., Hsin-Chu (TW)

(21) Appl. No.: 14/251,640

(22) Filed: Apr. 13, 2014

(30) Foreign Application Priority Data
Dec. 9, 2013 (TW) 102145167

(51) Int. Cl. H04N 5/232; H04N 5/225

(52) U.S. Cl. CPC H04N 5/23212; H04N 5/23222; H04N 5/23219; H04N 5/2258

(57) ABSTRACT

An automatic-focusing imaging capture device includes a first imaging capture module for generating a clue imaging information according to an object and a second imaging capture module for determining whether or not to re-focus for generating an imaging information corresponding to the object according to the clue imaging information; wherein a first frame rate of the first imaging capture module is higher than a second frame rate of the second imaging capture module, and the clue imaging information includes an object-distance information and a depth-of-field information.

### BACKGROUND OF THE INVENTION

1. Field of the Invention

The present invention relates to an automatic-focusing imaging capture device and an imaging capture method, and more particularly, to an automatic-focusing imaging capture device and an imaging capture method which utilize at least two imaging capture modules to fast capture pictures.

2. Description of the Prior Art

Conventional imaging capture devices, such as a digital camera, lenses of a mobile device or a digital single lens reflex camera (DSLR), are operated to move at least one focusing lens to capture/collect a plurality of imaging definition values corresponding to a plurality of positions, so as to obtain a highest imaging definition value from the plurality of imaging definition values, which means a focusing operation is completed, and a corresponding position of the highest imaging definition value is called a focus point of an object of the focusing lens.

In other words, whether the imaging capture devices can functionally operate is based on the focusing operation to be quickly completed, and the imaging definition value can be obtained via an auto-focusing (AF) sensor of the DSLR or an imaging sensor. An efficiency of the AF sensor is based on a capture rate thereof, which means that a faster moving speed of the focusing lens, a higher efficiency of the AF sensor. The image sensor is operated with a longer period of exposure to capture the images, which restricts the image sensor from being operated in higher sampling rates. Under such circumstances, if it is necessary to reduce a focusing period of the imaging capture device, an exposure period of single picture must be correspondingly shorten lowering imaging quality of the captured picture.

Besides, another imaging capture device, such as a video camera, is operated with a continuous AF mode, which means that the imaging capture device continuously processes the focusing operation to have the currently captured picture as a clear one. However, a continuous AF operation has its drawback as how to determine whether the captured picture has a highest imaging definition. A common operation is to process a scene detection for obtaining a corresponding characteristic value of every picture via an initiation focusing operation, so as to determine whether changes of the characteristic value are outside a predetermined range for processing another focusing operation again, wherein the characteristic value can be an average brightness of the picture, block brightness, definition, or positions of particular object(s). However, the mentioned continuous AF operation may result in errors being unable to correctly determine the characteristic value of every picture.

Therefore, it has been an important issue to provide another automatic-focusing imaging capture device and an imaging capture method.

### SUMMARY OF THE INVENTION

It has been the objective to provide an automatic-focusing imaging capture device and an imaging capture method which utilize at least two imaging capture modules to fast and conveniently capture images.

According to an aspect of the disclosure, an automatic-focusing imaging capture device comprises a first imaging capture module for generating a clue imaging information according to an object; and a second imaging capture module for determining whether or not to re-focus for generating an imaging information corresponding to the object according to the clue imaging information; wherein a first frame rate of the first imaging capture module is higher than a second frame rate of the second imaging capture module, and the clue imaging information comprises an object distance information and a depth-of-field information.

According to another aspect of the disclosure, an imaging capture method for an automatic-focusing imaging capture device comprising a first imaging capture module and a second imaging capture module comprises generating, via the first imaging capture module, a clue imaging information according to an object; and determining, via the second imaging capture module, whether or not to re-focus for generating an imaging information corresponding to the object according to the clue imaging information; wherein a first frame rate of the first imaging capture module is higher than a second frame rate of the second imaging capture module, and the clue imaging information comprises an object distance information and a depth-of-field information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an automatic-focusing imaging capture device according to an embodiment of the invention.

FIG. 2 illustrates a detailed schematic diagram of an automatic-focusing imaging capture device according to an embodiment of the invention.

FIG. 3 illustrates a detailed schematic diagram of another automatic-focusing imaging capture device according to an embodiment of the invention.

FIG. 4 illustrates a detailed schematic diagram of another automatic-focusing imaging capture device according to an embodiment of the invention.

FIG. 5 illustrates a detailed schematic diagram of another automatic-focusing imaging capture device according to an embodiment of the invention.

FIG. 6 illustrates a schematic diagram of a focusing look-up table according to an embodiment of the invention.

FIG. 7 illustrates a schematic diagram of a focusing look-up table according to an embodiment of the invention.

FIG. 8 illustrates a flow chart of an imaging capture process according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

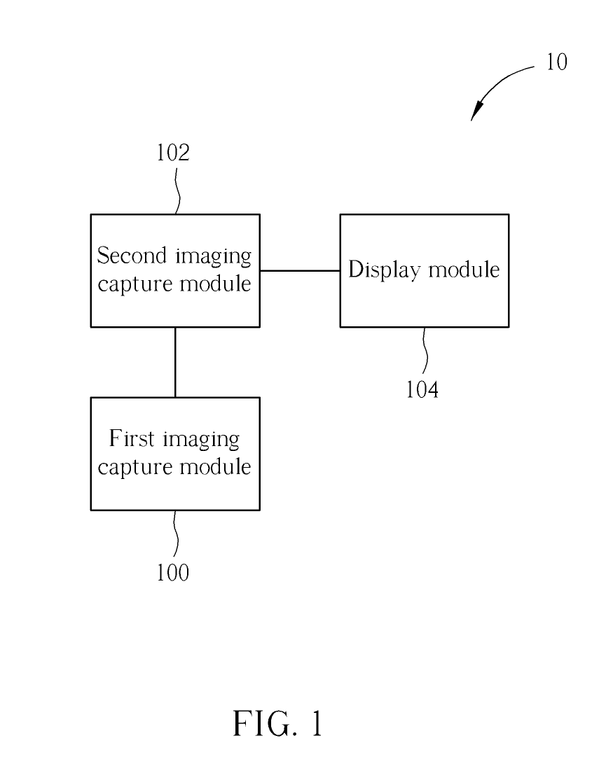

Please refer to FIG. 1, which illustrates a schematic diagram of an automatic-focusing imaging capture device 10 according to an embodiment of the invention. As shown in FIG. 1, the automatic-focusing imaging capture device 10 comprises a first imaging capture module 100, a second imaging capture module 102 and a display module 104. In the embodiment, the first imaging capture module 100 is electrically coupled to the second imaging capture module 102, and the display device 104 is electrically coupled to the second imaging capture module 102. Accordingly, the first imaging capture module 100 generates a clue imaging information according to an object, and the second imaging capture module 102 determines whether or not to re-focus for generating an imaging information corresponding to the object according to the clue imaging information, and lastly, the display module 104 displays the imaging information of the object. Certainly, the embodiment of the invention is not limiting the display module 104 for only displaying the imaging information, which means that the imaging information generated by the second imaging capture module 102 can also be transmitted to another computer system or an imaging processing server for adaptive operations of editing, outputting or backup according to different requirements of users, which is not limiting the scope of the invention.

In the embodiment, the clue imaging information generated by the first imaging capture module 100 comprises an object distance information and a depth-of-field information corresponding to the object. Accordingly, the second imaging capture module 102 determines whether or not to re-focus according to the object distance information and the depth-of-field information, or the second imaging capture module 102 correspondingly transforms and utilizes the object distance information and the depth-of-field information generated by the first imaging capture module 100 to obtain the imaging information corresponding to the object. Preferably, the first imaging capture module 100 and the second imaging capture module 102 correspond to a first frame rate and a second frame rate, respectively, and the first frame rate is higher than the second frame rate. Under such circumstances, the first imaging capture module 100 of the embodiment has a higher frame rate (i.e. a shorter sampling period for sampling one picture), such that the first imaging capture module 100 can finish the focusing operation with a shorter period, to correspondingly provide the object distance information and the depth-of-field information corresponding to the object to the second imaging capture module 102. In the meanwhile, the second imaging capture module 102 utilizes and transforms the clue imaging information generated by the first imaging capture module 100 and a lower frame rate (i.e. a longer sampling period for sampling one picture) to capture imaging information with better imaging quality, so as to output the imaging information for following displaying or editing by the users.

In brief, the automatic-focusing imaging capture device 10 of the embodiment simultaneously utilizes two imaging capture modules, wherein one imaging capture module (i.e. the first imaging capture module 100) provides an assistive imaging capture operation due to its higher frame rate with a shorter sampling period, and the other imaging capture module (i.e. the second imaging capture module 102) provides a main imaging capture operation due to its lower frame rate with better imaging quality of capturing pictures. Accordingly, the user can finish the focusing operation within a shorter period to obtain better imaging quality while sampling the picture(s). The conventional imaging capture device only comprises a single imaging capture module and it is necessary to choose one from two critical factors as the frame rate and the exposure period, so as to adaptively cooperate with an AF sensor or an image sensor for outputting the imaging information. In comparison, the automatic-focusing imaging capture device 10 of the embodiment has the advantage of capturing the picture(s) within a shorter period as well as a better imaging quality, which increases the application range of the automatic-focusing imaging capture device 10.

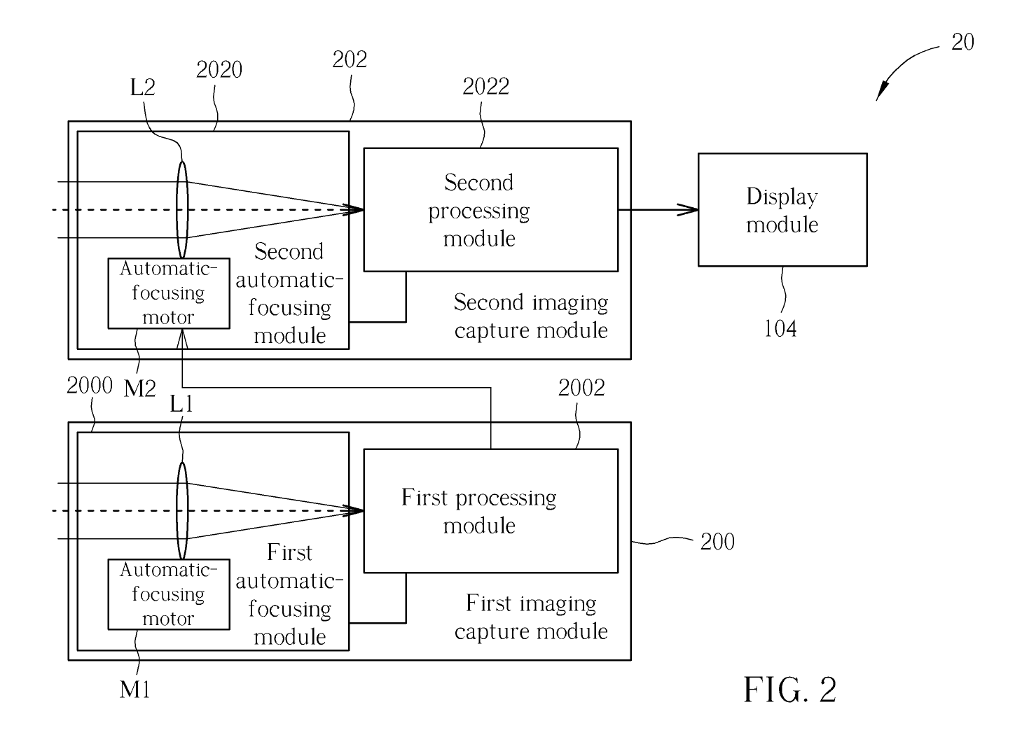

Please refer to FIG. 2, which illustrates a detailed schematic diagram of an automatic-focusing imaging capture device 20 according to an embodiment of the invention. In the embodiment, the automatic-focusing imaging capture device 20 show internal details of the automatic-focusing imaging capture device 10, and shares the same marks of the similar composition elements/units. As shown in FIG. 2, a first imaging capture module 200 comprises a first automatic-focusing module 2000 and a first processing module 2002, and a second imaging capture module 202 comprises a second automatic-focusing module 2020 and a second processing module 2022, wherein the first processing module 2002 of the first imaging capture module 200 is electrically coupled to the second automatic-focusing module 2020 of the second imaging capture module 202, and the second processing module 2022 of the second imaging capture module 202 is electrically coupled to the display module 104. In detail, the first automatic-focusing module 2000 further comprises an automatic-focusing lens L1 and an automatic-focusing motor M1 to generate a first picture information according to a position of the object. The first processing module 2002 is coupled to the first automatic-focusing module 2000 for receiving the first picture information and generating the clue imaging information. The second automatic-focusing module 2020 further comprises an automatic-focusing lens L2 and an automatic-focusing motor M2 to generate a second picture information according to the clue imaging information, and the second processing module 2022 is coupled to the second automatic-focusing module 2020 for receiving the second picture information and generating the imaging information.

Furthermore, the first processing module 2002 of the embodiment receives the first picture information to correspondingly generate a first definition value information to determine a current focusing condition of the sampling picture, so as to adaptively generate a feedback information to the automatic-focusing motor M1, such that the automatic-focusing motor M1 can adaptively adjust positions of the automatic-focusing lens L1 for continuously generating the first picture information to be transmitted to the first processing module 2002. In other words, the first automatic-focusing module 2000 obtains a plurality of picture information corresponding to a plurality of focusing points, and the first processing module 2002 is utilized to determine whether focusing operations corresponding to a plurality of first definition value information are done or not. If the focusing operation has not finished, the first processing module 2002 will generate the feedback information to be transmitted to the automatic-focusing motor M1, so as to inform the automatic-focusing motor M1 of an incomplete focusing operation, such that the automatic-focusing motor M1 adaptively adjusts positions of the automatic-focusing lens L1 (i.e. moving forward or backward relative to the sensor with a fixed displacement amount, or alternatively moving forward or backward relative to the sensor with a unfixed displacement amount around/near an predetermined focusing point to obtain the most clear definition value information) to continuously obtain the first picture information and the corresponding first definition value information, so as to determine whether or not to repeat such focusing operations for obtaining the plurality of first picture information and the corresponding first definition value information. If the focusing operation has finished, the first processing module 2002 will determine the object distance information and the depth-of-field information corresponding to the current object to integrate both the object distance information and the depth-of-field information as the clue imaging information to be transmitted to the second automatic-focusing module 2020 of the second imaging capture module 202.

Please refer to FIG. 2 again. In the second imaging capture module 202, the second automatic-focusing module 2020 receives the clue imaging information transmitted by the first processing module 2002 to generate the second picture information, and the second processing module 2022 is coupled to the second automatic-focusing module 2020 to receive the second picture information and generate the imaging information. Preferably, the second automatic-focusing module 2020 comprises the automatic-focusing lens L2 and the automatic-focusing motor M2, and the automatic-focusing motor M2 receives the object distance information and the depth-of-field information transmitted by the first processing module 2002, to determine whether or not to process the focusing operation again or to directly transform the object distance information and the depth-of-field information transmitted by the first processing module 2002 for generating the second picture information. Next, the second processing module 2022 receives and transforms the second picture information into second definition value information to be correspondingly outputted to the display module 104 for the following displaying or editing of the users.

Moreover, the second processing module 2022 can refer to the second picture information generated by the second automatic-focusing module 2020, to determine whether or not to process the focusing operation again. If the focusing operation is needed for processing again, the second processing module 2022 generates a feedback information to be transmitted to the automatic-focusing motor M2, so as to inform the automatic-focusing motor M2 of an incomplete focusing operation, such that the automatic-focusing motor M2 adaptively adjusts positions of the automatic-focusing lens L2 (i.e. moving forward or backward relative to the sensor with a fixed displacement amount, or alternatively moving forward or backward relative to the sensor with a unfixed displacement amount around/near an predetermined focusing point to obtain the most clear definition value information) to continuously obtain the second picture information and the corresponding second definition value information. Also, the second processing module 2022 continuously determines whether or not to repeat such focusing operations for obtaining the plurality of second picture information and the corresponding second definition value information. Otherwise, the second processing module 2022 will correspondingly generate the imaging information to be outputted to the display module 104 according to the at least one second picture information for the following displaying and editing of the users.

Noticeably, the first processing module 2002 and the second processing module 2022 further comprise a sensing unit (not shown in the figure) and an imaging processing unit (not shown in the figure), and for those skilled in the art, the sensing unit is coupled to the automatic-focusing lens L1 (or the automatic-focusing lens L2) to sense lights generated by the automatic-focusing lens L1 (or the automatic-focusing lens L2), so as to transform the first picture information (or the second picture information) to be transmitted to the imaging processing unit. Then, the imaging processing unit is utilized to calculate and generate the first definition value information (or the second definition value information) corresponding to the first picture information (or the second picture information), so as to output the clue imaging information (or the imaging information). Preferably, the first picture information or the second picture information of the embodiment can be an imaging format, such as the Raw Image Format (RAW), the Tagged Image File Format (TIFF), the Joint Photographic Experts Group (JPEG), the Bitmap Image File (BMP) or the Graphics Interchange Format (GIF), etc. The first definition value information or the second definition value information can be transformed via calculating of Sum-Modulus Difference (SMD). The imaging information can be realized to be identical to the imaging format of the first/second picture information, or be other imaging formats to be easily displayed and edited for the user, which is also in the scope of the invention.

Additionally, the numbers of the automatic-focusing lenses L1 and L2 and the automatic-focusing motors M1 and M2 of the embodiment are only examples/demonstrations herein. According to different requirements of the users or different dispositions of the object (or different positions of the object corresponding to the automatic-focusing imaging capture device), operations as well as the numbers of the automatic-focusing lenses L1 and L2 and the automatic-focusing motors M1 and M2 can be adaptively adjusted/changed/modified to correspondingly obtain the first/second picture information and the first/second definition value information, which is also in the scope of the invention.

Besides, the automatic-focusing lenses L1 and L2 of the embodiment can be designed with the same specifications or different specifications. When the automatic-focusing lenses L1 and L2 have different specifications, the first automatic-focusing module 2000 are necessary to adaptively comply with requirements of the fast focusing operation since the first imaging capture module 200 only provides the assistive imaging capture operation. Accordingly, optical imaging parameters, e.g. the focus of view of the lens, corresponding to the automatic-focusing lens L1 or resolution of the imaging sensor inside the first processing module 2002 can be utilized to provide the initial focusing operation. The second imaging capture module 202 provides the main imaging capture operation, and accordingly, more requirements for the imaging parameters, such as the focus of view, the color resolution, the color-temperature of the picture or saturation, of the automatic-focusing module 2020 and the second processing module 2022 are inevitable, in comparison with the first automatic-focusing module 2000 and the first processing module 2002, to provide complete/thorough focusing operation and imaging outputting operation.

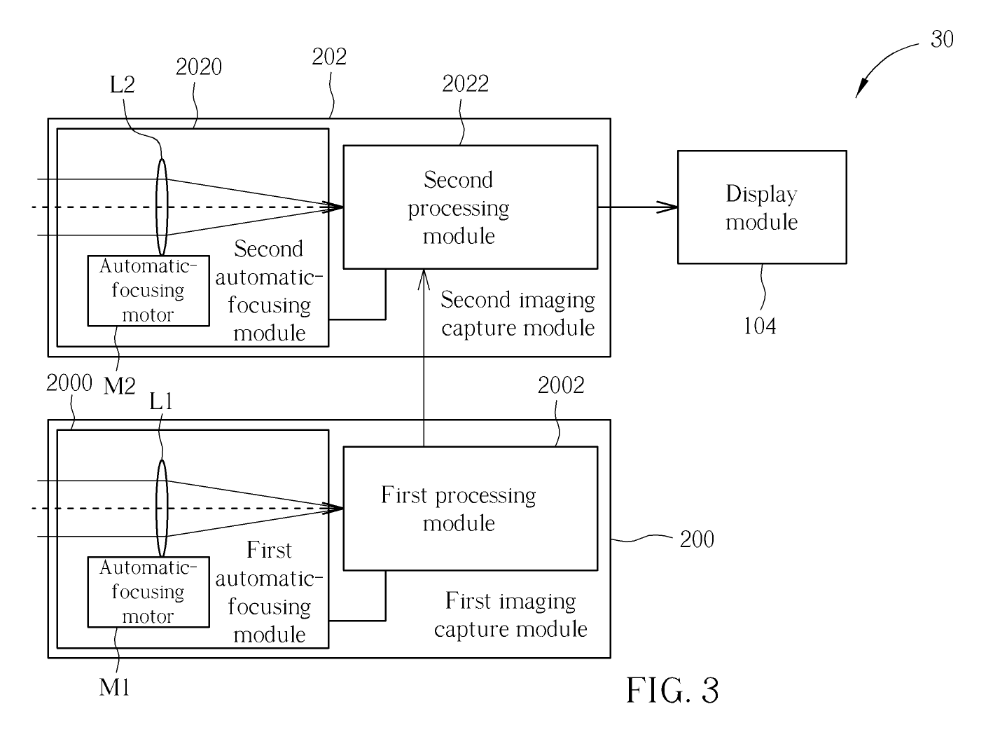

Please refer to FIG. 3, which illustrates a detailed schematic diagram of another automatic-focusing imaging capture device 30 according to an embodiment of the invention. As shown in FIG. 3, the automatic-focusing imaging capture device 30 in FIG. 3 is similar to the automatic-focusing imaging capture device 20 in FIG. 2, and the same marks of the similar elements/units are represented. A difference between the automatic-focusing imaging capture devices 20 and 30 is that, in the automatic-focusing imaging capture devices 30, the clue imaging information (comprising the object distance information and the depth-of-field information) generated by the first processing module 2002 is directly transmitted to the second processing module 2022, and the second processing module 2022 correspondingly determines whether or not to generate the feedback signal to the second automatic-focusing module 2020 for processing the focusing operation again. Next, the automatic-focusing motors M2 adjusts positions of the automatic-focusing lens L2 to obtain the clearest definition value information, or it is not necessary for the second automatic-focusing module 2020 to re-focus again, and accordingly, the automatic-focusing motors M2 refers to a transformation focus-distance position corresponding to the focus-distance position of the automatic-focusing lens L1, to move the automatic-focusing lens L2 for obtaining the second picture information, such that the second processing module 2022 outputs the imaging information.

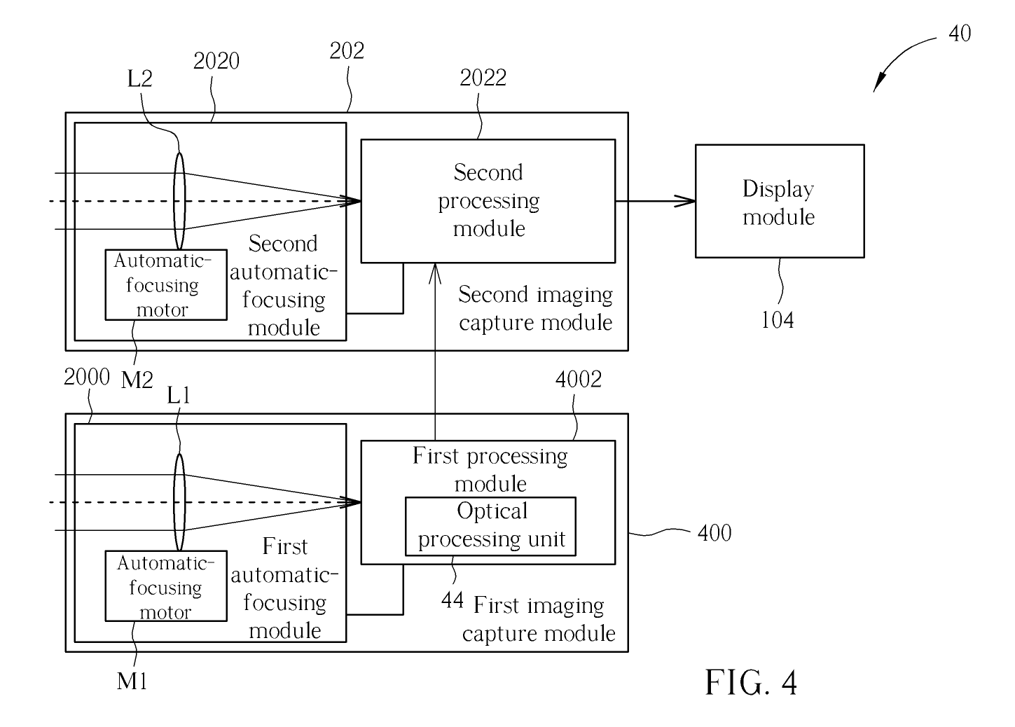

Please refer to FIG. 4, which illustrates a detailed schematic diagram of another automatic-focusing imaging capture device 40 according to an embodiment of the invention. As shown in FIG. 4, the automatic-focusing imaging capture device 40 in FIG. 4 is similar to the automatic-focusing imaging capture device 30 in FIG. 3, and the same marks of the similar elements/units are represented. A difference between the automatic-focusing imaging capture devices 30 and 40 is that, in the automatic-focusing imaging capture devices 40, a first processing module 4002 of a first imaging capture module 400 further comprises an optical processing unit 44, such that the optical processing unit 44 refers to the at least one first picture information generated by the first automatic-focusing module 2000 to correspondingly generate a statistic information, so as to provide the statistic information to the second processing module 2022. Accordingly, the second processing module 2022 determines whether or not to process another focusing operation of the automatic-focusing lens L2 and the automatic-focusing motors M2 inside the second automatic-focusing module 2020 again, so as to generate the second picture information and output the imaging information.

Preferably, the statistic information of the embodiment comprises a motion vector information, a shape information and a face detection information. For example, the first imaging capture module 200 has the picture information format as 320×240, and the first processing module 2002 utilizes an imaging sensor having the first frame rate as 200 frames per second (fps). Accordingly, the first imaging capture module 200 can obtain a more accurate motion vector information to be transmitted to the second imaging capture module 202, so as to elevate/improve stabilization of the second imaging capture module 202. In hardware designs, the first processing module 2002 can further utilize a mono imaging sensor, which is not necessary to be coupled with extra color filters as well as to process color interpolation calculation, such that the first imaging capture module 200 can correspondingly output better contrast of the picture information to obtain clearer and sharper shape information of the object. Also, the first imaging capture module 200 can cooperate with a face detection operation to generate a face detection information corresponding to the object to be transmitted to the second imaging capture module 202, so as to lessen a calculating burden of the second processing module 2022 and to reduce a period of the focusing operation.

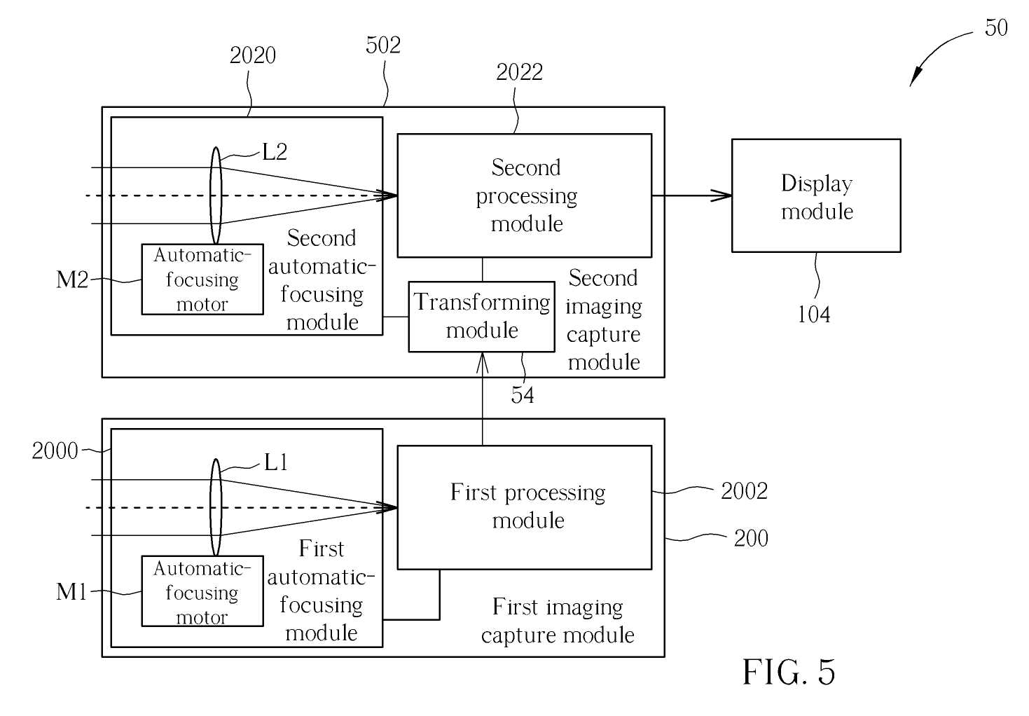

Please refer to FIG. 5, which illustrates a detailed schematic diagram of another automatic-focusing imaging capture device 50 according to an embodiment of the invention. As shown in FIG. 5, the automatic-focusing imaging capture device 50 in FIG. 5 is similar to the automatic-focusing imaging capture device 20 in FIG. 2, and the same marks of the similar elements/units are represented. A difference between the automatic-focusing imaging capture devices 20 and 50 is that, in the automatic-focusing imaging capture devices 50, a second imaging capture module 502 further comprises a transforming module 54 coupled to the second automatic-focusing module 2020. The second processing module 2022 is utilized to receive the clue imaging information (comprising the object distance information and the depth-of-field information) generated by the first processing module 2002, and a focusing look-up table predetermined by the transforming module 54 is utilized as well. Accordingly, the object distance information and the depth-of-field information of the clue imaging information being suitable for the automatic-focusing lens L1 and the automatic-focusing motor M1 can be adaptively transformed to form a focusing parameter information for the second automatic-focusing module 2020 to be provided to the second automatic-focusing module 2020 and the second processing module 2022 for processing the focusing operation again.

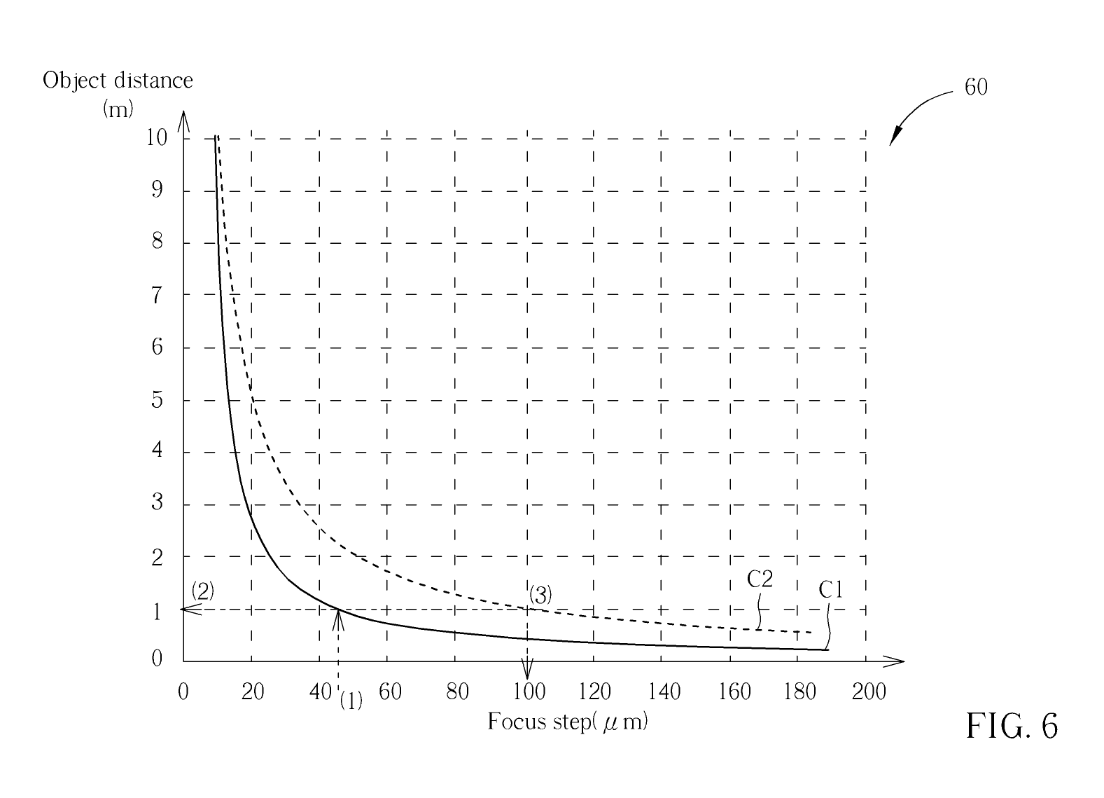

Please refer to FIG. 6, which illustrates a schematic diagram of a focusing look-up table 60 according to an embodiment of the invention, wherein the focusing look-up table 60 of the embodiment can be utilized in the automatic-focusing imaging capture device 20 shown in FIG. 2, i.e. the first processing module 2002 generates the clue imaging information to be transmitted to the second automatic-focusing module 2020 and the second automatic-focusing module 2020 determines whether or not to process the focusing operation to generate the imaging information. As shown in FIG. 6, after the first processing module 2002 completes the focusing operation, a focus step as 44 micrometer (um) corresponding to the automatic-focusing lens L1 is obtained. By utilizing a transformation curve C1 of the automatic-focusing lens L1, an object distance corresponding to the object is obtained as 1 meter. Next, by utilizing another transformation curve C2 of the automatic-focusing lens L2, a focus step for the automatic-focusing lens L2 is obtained as 100 um. Lastly, the automatic-focusing motor M2 moves the automatic-focusing lens L2 to finish the focusing operation of the second automatic-focusing module 2020, so as to output the second picture information to the second processing module 2022 for generating the imaging information.

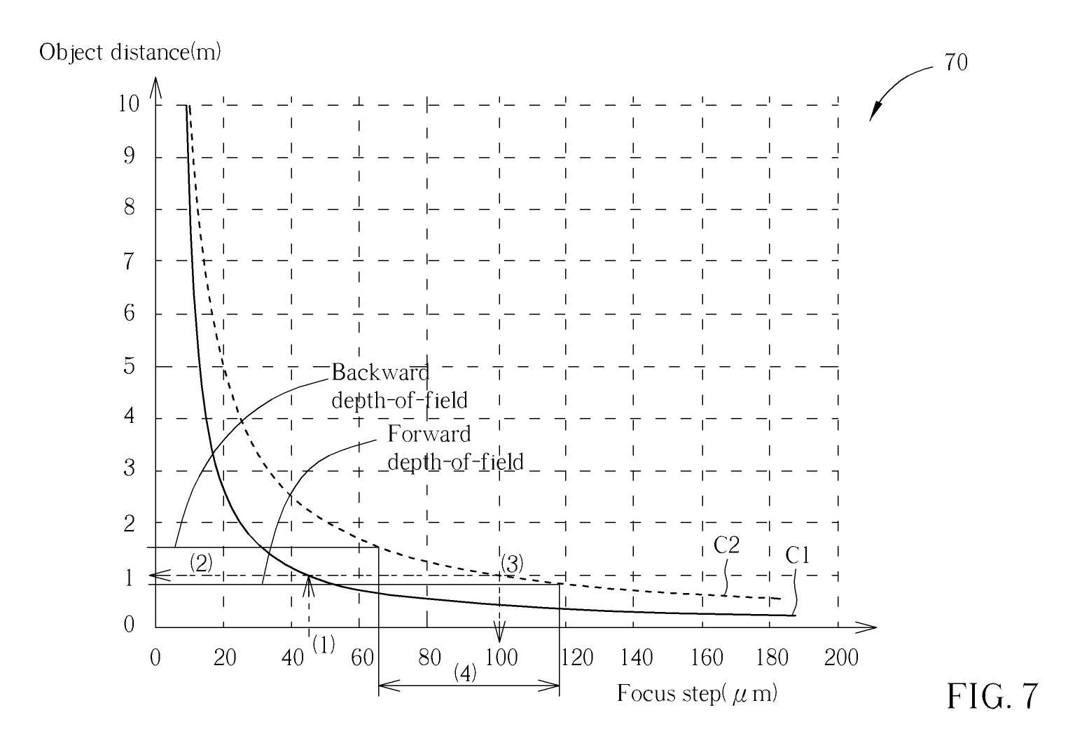

Please refer to FIG. 7, which illustrates a schematic diagram of a focusing look-up table 70 according to an embodiment of the invention, wherein the focusing look-up table 70 of the embodiment can be utilized in the automatic-focusing imaging capture device 30 (i.e. the first processing module 2002 generates the clue imaging information to be transmitted to the second processing module 2022 and the second processing module 2022 determines whether or not to process the focusing operation to generate the imaging information) shown in FIG. 3. As shown in FIG. 7, after the first processing module 2002 completes the focusing operation, a focus step as 44 um corresponding to the automatic-focusing lens L1 is obtained. By utilizing a transformation curve C1 of the automatic-focusing lens L1, an object distance corresponding to the object is obtained as 1 meter, and a forward depth-of-field is obtained as 0.8 meter and a backward depth-of-field is obtained as 1.5 meters. Next, by utilizing another transformation curve C2 of the automatic-focusing lens L2, a focus step of the forward depth-of-field for the automatic-focusing lens L2 is obtained as 65 um, and a focus step of the backward depth-of-field for the automatic-focusing lens L2 is obtained as 118 um. Lastly, the automatic-focusing motor M2 moves the automatic-focusing lens L2 within a range from 65 um to 118 um to finish the focusing operation of the second automatic-focusing module 2020, so as to output the second picture information to the second processing module 2022 for generating the imaging information.

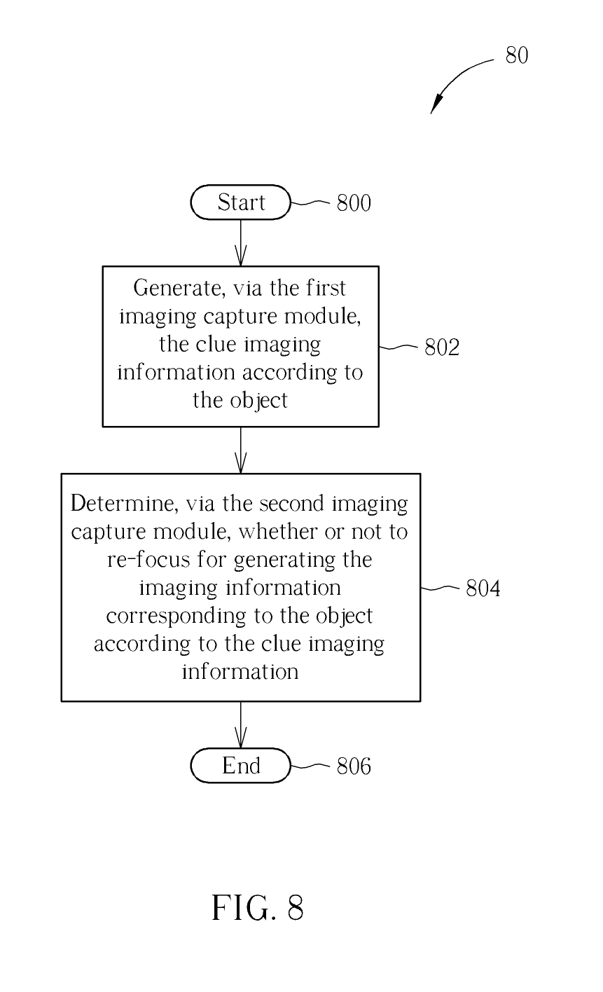

Furthermore, an imaging capture method of the automatic-focusing imaging capture device of the invention can be summarized as an imaging capture process 80, as shown in FIG. 8. The imaging capture process 80 includes the following steps:

Step 800: Start.

Step 802: Generate, via the first imaging capture module, the clue imaging information according to the object.

Step 804: Determine, via the second imaging capture module, whether or not to re-focus for generating the imaging information corresponding to the object according to the clue imaging information.

Step 806: End.

Detailed operations of the imaging capture process 80 can be understood via related paragraphs and figures of the automatic-focusing imaging capture devices 10, 20 and 30, which is not described hereinafter for brevity. Preferably, step 804 further comprises utilizing the second automatic-focusing module or the second processing module of the second imaging capture module to receive the clue imaging information (or the clue imaging information can be received by the transforming module, and the transformed clue imaging information can be adaptively transmitted to the second automatic-focusing module or the second processing module), so as to determine whether the second imaging capture module is necessary for processing the focusing operation again, such that the second processing module correspondingly outputs the imaging information to the display module. Certainly, those skilled in the art can adaptively modify application ranges of the embodiments to make the display module simultaneously display the clue imaging information generated by the first imaging capture module and the imaging information generated by the second imaging capture module, so as to process related editing operations or comparison operations of the clue imaging information and the imaging information, which is also in the scope of the invention.

In summary, the embodiments of the invention simultaneously utilize two imaging capture modules, wherein one imaging capture module is the assistive imaging capture module with a higher frame rate to fast sample pictures in a shorter period, and the other imaging capture module is the main imaging capture module with a lower frame rate to maintain better imaging quality. Accordingly, the user can utilize the focusing condition of the assistive imaging capture module to determine the focusing operation of the main imaging capture module, which leads to a situation that the focusing operation of the automatic-focusing imaging capture module can be done in the shorter period accompanying the better imaging quality, and the application range of the automatic-focusing imaging capture device is correspondingly increased/broaden.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic-focusing imaging capture device, comprising:
a first imaging capture module for generating a clue imaging information according to an object; and
a second imaging capture module for determining whether or not to re-focus for generating an imaging information corresponding to the object according to the clue imaging information;
wherein a first frame rate of the first imaging capture module is higher than a second frame rate of the second imaging capture module, and the clue imaging information comprises an object distance information and a depth-of-field information.

2. The automatic-focusing imaging capture device of claim 1, wherein the first imaging capture module comprises:
a first automatic-focusing module, for generating a first picture information according to a position of the object; and
a first processing module, coupled to the first automatic-focusing module for generating the clue imaging information according to the first picture information.

3. The automatic-focusing imaging capture device of claim 2, wherein the first automatic-focusing module further comprises an automatic-focusing lens and an automatic-focusing motor, and the first processing module further generates a feedback information to the automatic-focusing motor, such that the automatic-focusing motor correspondingly adjusts a position of the automatic-focusing lens to generate the first picture information.

4. The automatic-focusing imaging capture device of claim 3, wherein the first processing module further generates a statistic information to the second imaging capture module according to the first picture information.

5. The automatic-focusing imaging capture device of claim 4, wherein the statistic information comprises a motion vector information, a shape information and a face detection information.

6. The automatic-focusing imaging capture device of claim 1, wherein the second imaging capture module comprises:
a second automatic-focusing module, for generating a second picture information according to the clue imaging information; and
a second processing module, coupled to the first automatic-focusing module for generating the imaging information according to the second picture information.

7. The automatic-focusing imaging capture device of claim 6, wherein the second automatic-focusing module further comprises an automatic-focusing lens and an automatic-focusing motor, and the second processing module further generates a feedback information to the automatic-focusing motor, such that the automatic-focusing motor correspondingly adjusts a position of the automatic-focusing lens to generate the second picture information.

8. The automatic-focusing imaging capture device of claim 6, wherein the second processing module further determines whether the automatic-focusing motor re-focuses to generate the second picture information according to the clue imaging information.

9. The automatic-focusing imaging capture device of claim 6, wherein second processing module further receives a statistic information generated by the first imaging capture module to determine whether the second automatic-focusing module re-focuses to generate the second picture information, so as to generate the imaging information.

10. The automatic-focusing imaging capture device of claim 6, wherein the second imaging capture module further comprises a transforming module to receive the object distance information and the depth-of-field information of the clue image information, and a focusing look-up table of the transforming module is utilized to generate a focusing parameter information suitable for the second automatic-focusing module.

11. An imaging capture method for an automatic-focusing imaging capture device comprising a first imaging capture module and a second imaging capture module, the imaging capture method comprising:
generating, via the first imaging capture module, a clue imaging information according to an object; and
determining, via the second imaging capture module, whether or not to re-focus for generating an imaging information corresponding to the object according to the clue imaging information;
wherein a first frame rate of the first imaging capture module is higher than a second frame rate of the second imaging capture module, and the clue imaging information comprises an object distance information and a depth-of-field information.

12. The imaging capture method of claim 11, further comprising utilizing a first automatic-focusing module of the first imaging capture module for generating a first picture information according to a position of the object, and utilizing a first processing module of the first imaging capture module and the first picture information for generating the clue imaging information.

13. The imaging capture method of claim 12, further comprising utilizing the first processing module to generate a feedback information to an automatic-focusing motor of the first automatic-focusing module, so as to correspondingly adjust a position of an automatic-focusing lens of the first automatic-focusing module and to generate the first picture information.

14. The imaging capture method of claim 13, further comprising utilizing the first processing module for processing the first picture information to generate a statistic information to the second imaging capture module.

15. The imaging capture method of claim 14, wherein the statistic information comprises a motion vector information, a shape information and a face detection information.

16. The imaging capture method of claim 11, further comprising utilizing a second automatic-focusing module of the second imaging capture module and the clue imaging information for generating a second picture information, and utilizing a second processing module of the second imaging capture module and the second picture information for generating the imaging information.

17. The imaging capture method of claim 16, further comprising utilizing the second processing module to generate a feedback information to an automatic-focusing motor of the second automatic-focusing module, so as to correspondingly adjust a position of an automatic-focusing lens of the second automatic-focusing module and to generate the second picture information.

18. The imaging capture method of claim 16, further comprising utilizing the second processing module for receiving the clue imaging information to determine whether the automatic-focusing motor re-focuses to generate the second picture information.

19. The imaging capture method of claim 16, further comprising utilizing the second processing module for receiving a statistic information generated by the first imaging capture module, to determine whether the second automatic-focusing module re-focuses to generate the second picture information, so as to generate the imaging information.

20. The imaging capture method of claim 16, further comprising utilizing a transforming module of the second imaging capture module to receive the object distance information and the depth-of-field information of the clue image information, and utilizing a focusing look-up table of the transforming module to generate a focusing parameter information suitable for the second automatic-focusing module.
